(19) United States
(12) Patent Application Publication
(10) Pub. No.: US 2007/0231424 A1
(43) Pub. Date: Oct. 4, 2007

(54) LONG-DURATION ENCAPSULATED FLAVORS AND CHEWING GUM USING SAME

(76) Inventors: Armando J. Castro, Westchester, IL (US); Sonya S. Johnson, LeGrange Highlands, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 11/687,519

(22) Filed: Mar. 16, 2007

Related U.S. Application Data
(60) Provisional application No. 60/787,963, filed on Mar. 31, 2006.

(51) Int. Cl. A23G 4/00

(52) U.S. Cl. 426/3

(57) ABSTRACT

A chewing gum composition comprises about 5% to about 95% gum base, about 5% to about 96% bulking and sweetening agents, and about 0.1% to about 15% flavor, wherein at least part of the flavor is a long-duration flavor material comprising a vinyl polymer encapsulated matrix. The matrix itself includes about 30% to about 60% acacia gum, about 30% to about 60% corn syrup solids having a DE of between about 24 and about 44 or equivalent hydrogenated starch hydrolysates, and about 2% to about 20% hydrocolloid material, with the acacia gum and corn syrup solids or hydrogenated starch hydrolysates together comprising at least 80% of the matrix. The vinyl polymer comprises between about 30% and about 80% of the long-duration flavor material.

### RELATED APPLICATION

The present application claims the benefit under 35 U.S.C. § 119(e) of Provisional U.S. Patent Application Ser. No. 60/787,963, filed Mar. 31, 2006, which is hereby incorporated by reference in its entirety.

### BACKGROUND OF THE INVENTION

The present invention relates to flavored chewing gums that have long lasting flavor, as well as improved flavor retention using flavor encapsulation, as well as methods of encapsulating flavor, the resulting encapsulated flavor and methods of making such chewing gum.

Conventional mint flavored chewing gums are made with spearmint and peppermint flavor oils, which are also called essential oils and have a very high boiling point. These mint flavors are generally retained in the chewing gum for the entire shelf life of the product. Other essential oils are fruit flavored oils such as orange oil or lemon oil, or spice oils such as clove oil and wintergreen oil (methyl salicylate). These fruit or spice flavor oils have a relatively high boiling point, thus these also are retained in the chewing gum during its normal shelf life. However, many other fruit flavors are from flavor esters, and some of these esters have very high vapor pressures, and thus very low boiling points. Consequently, the low boiling flavor esters have a tendency to evaporate from the chewing gum and thus are not retained over the normal shelf life of the product. This causes a loss of taste if only the esters are used. Also, for mixed fruit flavors, which use a combination of fruit esters and orange, lemon and spice oils, the mixed fruit flavor changes during the shelf life of the chewing gum product.

Due to the characteristics of chewing gum, much higher levels of flavor are used in chewing gum than in other types of confections. As a result, the flavor changes are more dramatic in gum products than in other types of confections, especially when some of the flavor is lost due to volatility.

Various known methods to improve retention of volatile flavors involve encapsulation, either by spray drying with a variety of components, such as gum arabic or maltodextrins, or absorption onto various carriers, or by extrusion into a maltodextrin/polymer matrix Some of these methods have not always been completely successful in retaining volatile flavors in chewing gum. While some other of the methods have been successful, they are also fairly complicated and/or expensive. Hence, there is a long felt need for a simple, fairly inexpensive method of treating volatile flavors, especially fruit esters, so that they are not lost from chewing gum as the gum undergoes its normal shelf life storage. U.S. Pat. No. 7,022,352, incorporated herein by reference in its entirety, discloses an improved encapsulation process that was found to provide exceptionally good retention of the volatile fruit esters.

One additional area for improvement is the flavor duration of chewing gum. One would like the flavor to be present over as long of a time period as possible while chewing the gum. However, efforts to encapsulate flavors to prevent them from evaporating tend to also make the flavor release more quickly from the gum. Hence, it would be a great improvement if there were a way to both increase the retention of flavor in the gum as it is stored, and to make the flavor chew out of the gum more gradually.

### SUMMARY OF THE INVENTION

A method of encapsulating flavors has been developed that is simple, and gives the flavors good retention over the normal shelf life storage of chewing gum into which they are mixed, yet surprisingly increases the flavor duration of the gum. The invention is useful for all types of flavors, but is preferred for volatile flavors.

In a first aspect the invention is a method of encapsulating flavor to provide a long-duration flavor material comprising: providing a flavor; providing encapsulating ingredients comprising acacia gum, corn syrup solids having a DE of between about 24 and about 44 or equivalent hydrogenated starch hydrolysates, and hydrocolloid material; encapsulating the flavor with a matrix comprising about 30% to about 60% acacia gum, about 30% to about 60% corn syrup solids or hydrogenated starch hydrolysates, and about 2% to about 20% hydrocolloid material to form an encapsulated flavor material, and further combining the encapsulated flavor material with a vinyl polymer to incorporate the encapsulated flavor into a long-duration flavor material comprising the vinyl polymer.

In a second aspect the invention is long-duration flavor material comprising about 30% to about 80% vinyl polymer and about 20% and about 70% encapsulated flavor; wherein the encapsulated flavor comprises about 5% to about 25% flavor and a matrix encapsulating the flavor, the matrix comprising about 30% to about 60% acacia gum, about 30% to about 60% corn syrup solids having a DE of between about 24 and about 44 or equivalent hydrogenated starch hydrolysates; and about 2% to about 20% hydrocolloid material, wherein the matrix comprises at least 80% acacia gum and corn syrup solids or hydrogenated starch hydrolysates on a combined basis.

In a third aspect the invention is a method of making a chewing gum product comprising the steps of encapsulating a flavor in a matrix comprising about 30% to about 60% acacia gum, about 30% to about 60% corn syrup solids having a DE of between about 24 and about 44 or equivalent hydrogenated starch hydrolysates, and about 2% to about 20% hydrocolloid material, the matrix comprising at least 80% acacia gum and corn syrup solids or hydrogenated starch hydrolysates on a combined basis; further combining the encapsulated flavor material with a vinyl polymer to incorporate the encapsulated flavor into a long-duration flavor material comprising the vinyl polymer; mixing the long-duration flavor material with gum base and one or more bulking and sweetening agents to form a chewing gum composition; and forming the chewing gum composition into a chewing gum product.

In a fourth aspect the invention is a chewing gum composition comprising about 5% to about 95% gum base, about 5% to about 96% bulking and sweetening agents, and about 0.1% to about 15% flavor, wherein at least part of the flavor comprises a long-duration flavor material comprising a vinyl polymer encapsulated matrix, wherein the matrix comprises about 30% to about 60% acacia gum, about 30% to about 60% corn syrup solids having a DE of between about 24 and about 44 or equivalent hydrogenated starch hydrolysates, and about 2% to about 20% hydrocolloid material, the matrix comprising at least 80% acacia gum and corn syrup solids or hydrogenated starch hydrolysates on a combined basis.

The encapsulation of the present invention provides a simple and low cost but effective encapsulation of flavors, particularly volatile flavors, and provides a surprisingly long flavor duration when mixed into chewing gum compositions. As a result, chewing gum made with the encapsulated flavor of the present invention can have a long shelf life, maintain its flavor level, or the correct blend of flavors, for commercially significant shelf life periods, and also provide long lasting flavor when chewed.

The invention and its advantages will be better understood in view of the attached drawings.

### BRIEF DESCRIPTION OF THE DRAWINGS

FIG. 1 is a graph showing test results of one example matrix of the invention and some comparative examples.

FIG. 2 is another graph, showing test results of second and third example matrices of the invention and some comparative examples.

FIG. 3 is another graph, showing flavor duration test results of fourth and fifth examples of the invention and a control.

FIG. 4 is another graph, showing sweetness duration test results of fourth and fifth examples of the invention and a control.

FIG. 5 is another graph, showing flavor duration test results of the fifth example of the invention and some comparative examples.

FIG. 6 is another graph, showing sweetness duration test results of the fifth example of the invention and some comparative examples.

### DETAILED DESCRIPTION OF THE DRAWINGS AND PREFERRED EMBODIMENTS OF THE INVENTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In the description that follows, all percentages are weight percentages unless otherwise indicated. The term chewing gum as used herein and in the claims that follow also includes bubble gum and the like. First the aspect of the invention relating to stability will be described, followed by the aspect relating to long-duration flavor.

Some flavor components that are volatile and are lost during the shelf life of the gum product are:

| | Boiling Point (° C.) | Flash Point (° F.) |
|---|---|---|
| Ethyl butyrate | 120 | 67 |
| Isoamyl acetate | 142 | 77 |
| Ethyl propionate | 99 | 54 |
| Ethyl acetate | 77 | 26 |
| Ethyl caproate | 167 | 121 |
| Amyl acetate | 142 | 75 |
| Ethyl isobutyrate | 112 | 57 |
| Propyl acetate | 102 | 67 |
| Isobutyl acetate | 115 | 71 |

Some non-volatile flavor components often used in chewing gum are:

| | Boiling Point (° C.) | Flash Point (° F.) |
|---|---|---|
| Lemon oil | 176 | 130 |
| Orange oil | 175 | 130 |
| Clove oil | 251 | 230 |
| Peppermint oil | 210 | 170 |
| Spearmint oil | 220 | 200 |
| Cinnamaldehyde | 240 | 160 |
| Methyl salicylate | 222 | >230 |

Flavors that are volatile are also relatively low boiling point compounds compared to other non-volatile flavors, as can be seen from the boiling point information above. Volatile flavor components generally have a boiling point below about 160° C. These materials also have a very low flash point, which could cause them to be flammable. Generally, the flash point for the volatile flavor components is less than about 120° F. Since many of the non-volatile flavor components may also contain some low boiling point components in them, the disclosed spray drying matrix may also be used to give a more stable spray dried matrix retaining the entire flavor.

A matrix of acacia gum, such as gum arabic; corn syrup solids having a DE of about 24 to about 44 or equivalent hydrogenated starch hydrolysates; and hydrocolloid material, has been found to give an improved encapsulated product containing the flavor. In an embodiment, the matrix may have a ratio of 10 parts gum arabic, 10 parts corn syrup solids having a DE of about 24-44 or equivalent hydrogenated starch hydrolysates, and 1 part hydrocolloid material. In order to avoid some regulatory issues in some foreign countries when gelatin is used as the hydrocolloid, the most appropriate gelatin to use is fish gelatin. This unique matrix has been shown to give good retention of volatile flavors in chewing gum.

The matrix containing these three components should be within the range of about 30-60% acacia gum, about 30-60% corn syrup solids having a DE of about 24-44 or equivalent hydrogenated starch hydrolysates, and about 2-20% hydrocolloid material, with the combination of acacia gum and corn syrup solids or hydrogenated starch hydrolysates being at least 80% of the matrix. In an embodiment, the range should be about 40-50% acacia gum, about 40-50% corn syrup solids having a DE of about 24-44 or equivalent hydrogenated starch hydrolysates, and about 2-10% hydrocolloid material. The ratio of acacia gum to corn syrup solids or hydrogenated starch hydrolysates is generally between about 2:1 and about 1:2, and the ratio of hydrocolloid material to the total of acacia gum and corn syrup solids or hydrogenated starch hydrolysates is between about 5:1 and about 40:1. Most preferably the ratio of acacia gum:corn syrup solids or hydrogenated starch hydrolysates:hydrocolloid material is about 1:1:0.1.

The finished encapsulated flavor composition should be about 5-25% flavor, about 24-48% acacia gum, about 24-48% corn syrup solids having a DE of about 24-44 or equivalent hydrogenated starch hydrolysates, and about 2-16% hydrocolloid material. In an embodiment, the final encapsulated flavor composition should be about 15-20% flavor, about 30-40% acacia gum, about 30-40% corn syrup solids having a DE of about 24-44 or equivalent hydrogenated starch hydrolysates, and about 2-8% hydrocolloid material. The ratio of the flavor to the matrix is preferably between about 1:4 and about 1:20.

The preferred acacia gum is gum arabic, which comes from Acacia Senegal. A preferred gum arabic is VALSPRAY A 53000, a spray dried gum arabic supplied by VALMAR, Z.I. St. Mitre, 13400 Aubagne, France. The moisture in this material is less than 10%. Gum arabic from Acacia Seyal (sometimes referred to as guru talha) may also be used. The low moisture content of commercially supplied acacia gum, as well as other ingredients used to make the matrix, is ignored in the present description and claims. Thus, the amounts of acacia gum used in the examples is recited as if commercially supplied acacia gum was 100% acacia gum and had no moisture.

The preferred corn syrup solids have a DE of between about 24 and about 44. Equivalent hydrogenated starch hydrolysates are likewise preferred. In an embodiment, the corn syrup solids have a DE of between about 30 and about 44. More preferably the corn syrup solids have a DE of between about 36 and about 44. In an embodiment of the invention, the corn syrup solids have a DE of about 44. A suitable corn syrup solids product is STAR-DRI 42 from A.E. Staley Manufacturing Co., 2200 E. Eldorado St., Decatur, Ill. Equivalent hydrogenated starch hydrolysates to each of the above ranges of DE can also be used. (Of course, when discussing hydrogenated starch hydrolysates, the term DE is not used. In the present application it is to be understood that the term “equivalent hydrogenated starch hydrolysates”, when referring to a specific DE corn syrup, means hydrogenated starch hydrolysates that would be produced if a corn syrup having that DE were hydrogenated.)

The hydrocolloid materials may include carrageenan, agar-agar, alginates, tamarind, pectin, pullulan, guar gum and guar gum hydrolysates, karaya gum, pectin, gellan gum, curdlan, arabinogalactan, and gelatin. These can be used individually or in combinations. Hydrocolloids are hydrophilic polymers of vegetable, animal, microbial or synthetic origin. Preferred hydrocolloid materials include carrageenan, pectin, agar-agar and alginates, with carrageenan presently being most preferred. When gelatin is used, a preferred gelatin is fish gelatin, such as high molecular weight, kosher, dried fish gelatin from Norland Products Incorporated, Building 100, 2540 Route 130, Cranbury, N.J. 08512. This gelatin is preferred because it does not contain protein from beef or pork sources, and therefore has less regulatory constraints. However, it is believed that other comparable gelatins will also work in the present invention. The amount of hydrocolloid material needed will depend on the hydrocolloid material used, as will be understood by one of ordinary skill in the art.

The volatile flavors that are particularly useful when encapsulated according to the present invention include ethyl butyrate, isoamyl acetate, ethyl propionate, ethyl acetate, ethyl caproate, amyl acetate, ethyl isobutyrate, propyl acetate, isobutyl acetate and mixtures thereof, and mixtures of the above with other flavors such as orange oil, lemon oil, clover oil, peppermint oil, spearmint oil, cinnamaldehyde, methyl salicylate and mixtures thereof.

Spray drying is the most common and economical method of encapsulating the flavors to form the matrix that provides volatile flavor retention, although other encapsulation techniques may be used. The mixture used for the spray drying will generally comprise about 0% to about 60% water, about 32% to about 10% encapsulating ingredients and about 5% to about 12% flavor prior to being spray dried. To prepare flavors for spray drying, the carrier or wall material (the acacia gum, corn syrup solids or hydrogenated starch hydrolysates and hydrocolloid material) is hydrated to give a 40-50% solution. For the comparative and inventive examples 1-3 described hereafter, a 50% solution of acacia gum was hydrated overnight. The corn syrup solids and gelatin were hydrated for a few minutes to give a 50% solution just before mixing with the acacia gum solution and the flavor. The flavor was added to the mix of acacia gum and the other ingredients and homogenized. The ratio of solids to flavor material was about 4:1. The mixture was homogenized to create small droplets of flavor within the carrier solution. It is believed that the creation of a finer emulsion increases the retention of flavor during the spray drying process. The flavor/carrier mixture was fed into a Niro Atomizer Spray Dryer, where it was atomized through a spinning wheel. Hot air flowing in co-current direction contacted the atomized particles and evaporated the water. This produced dried particles having the matrix containing small droplets of flavor. The dried particles fell to the bottom of the dryer and were collected. The inlet temperature for spray drying was between 180-205° C. and the outlet temperature was between 80-105° C. Preferably the spray drying inlet temperature will be between about 190° C. and about 200° C.

The matrix provided according to the foregoing, while providing a good retention of volatile flavor components, will not result in a long flavor duration when mixed into chewing gum. To increase the flavor duration, the matrix is combined with a vinyl polymer, such as polyvinyl acetate, to further encapsulate the flavor matrix. The matrix and vinyl polymer may be combined by any processes that melts the polymer and mixes the two so that the polymer encapsulates or coats the matrix. For example, the encapsulated flavor and polyvinyl acetate may be mixed together and heated to a temperature of between about 75° C. and about 110° C., such as by extrusion. One method of combining the matrix and vinyl polymer is the process disclosed in U.S. Pat. No. 5,229,148, incorporated herein by reference.

In addition to polyvinyl acetate, the vinyl polymers may be chosen from the group consisting of polyvinyl stearate; polyvinyl butyrate; polyvinyl propionate; polyvinyl alkanoates; copolymers of vinylacetate, vinyllaurate, vinylacetate and vinylalkanoates; and polymers of ethylene-vinyl acetate, butylene-vinylacetate, and other alkenyl-vinylacetates. The ratio of vinyl polymer to flavor matrix will typically be in the range of about 3:1 and about 1-3. Typically the long-duration flavor material comprises between about 20% and about 70% encapsulated flavor and about 30% to about 80% vinyl polymer. Thus, the long-duration flavor material may comprise about 4% to about 15% flavor, about 10% to about 30% gum arabic, about 10% to about 30% corn syrup solids or hydrogenated starch hydrolysates, about 1% to about 10% hydrocolloid material and about 20% to about 75% vinyl polymer. The long-duration flavor material will typically have a flavor loading of between about 5% and about 20%.

In one exemplary method of making the long-duration flavor material, a dry blended mixture of encapsulated flavor and polyvinyl acetate are heated in an extruder to a temperature of between about 75° C. and about 110° C. A suitable polyvinyl acetate for use in the invention has a weight average molecular weight of between about 25,000 and about 100,000. Several suitable polyvinyl acetates are VINNAPAS® B 14 SP (molecular weight between 25,000-33,000); VINNAPAS® B 30 SP (molecular weight between 45,000-55,000); and VINNAPAS® B 100 SP (molecular weight between 80,000-100,000), all from Wackeri Chemical Corporation, 3301 Sutton Road, Adrian, M149221-9397. In an embodiment, the polyvinyl acetate has a weight average molecular weight of about 50,000 to about 80,000.

After the matrix is encapsulated in the vinyl polymer, it will usually be ground or otherwise have its particle size reduced. The polymer should provide an extrudate that is hard enough to be milled. If a soft polymer is used, fillers like nanoclay, silica dioxide, talc, etc. may by added to a lower molecular weight vinyl polymer. Typically the ground material will be separated into fractions or cuts, with the desired particle size being used and the large and small particles being reground or extruded again. The fraction used will typically have a weight average particle size of between about 100 microns and about 1000 microns. One example long-duration flavor material has a particle size such that it passes through a USA standard testing sieve #18 but stays on a USA standard testing sieve #20, giving it particle sizes between about 840 microns and about 1000 microns.

The long-duration flavor material may further comprise a high-intensity sweetener, usually at a level of between about 0.1% and about 5%. The long-duration flavor material will usually be added to the chewing gum so that it comprises about 1% to about 20% of the chewing gum composition.

The long-duration flavor material of the present invention can be utilized in a wide variety of chewing gum compositions, including sugar gums and sugarless gums, formed into a wide variety of products, including gum sticks as well as pellets or balls.

In general, a chewing gum composition typically comprises a water-soluble bulk portion, a water-insoluble chewable grams base portion and typically water-insoluble flavoring agents. The water-soluble portion dissipates with a portion of the flavoring agent over a period of time during chewing. The gum base portion is retained in the mouth throughout the chew.

The insoluble gum base generally comprises elastomers, resins, fats and oils, softeners and inorganic fillers. The gum base may or may not include wax. The insoluble gum base can constitute approximately 5% to about 95% by weight of the chewing gum, more commonly the gum base comprises 10% to about 50% of the gum, and in some embodiments approximately 25% to about 35% by weight, of the chewing gum.

In a particular embodiment, the chewing gum base of the present invention contains about 20% to about 60% by weight synthetic elastomer, about 0% to about 30% by weight natural elastomer, about 5% to about 55% by weight elastomer plasticizer, about 4% to about 35% by weight filler, about 5% to about 35% by weight softener, and optional minor amounts (about 1 or less by weight) of miscellaneous ingredients such as colorants, antioxidants, etc.

Synthetic elastomers may include, but are not limited to, polyisobutylene with GPC weight average molecular weight of about 10,000 to about 95,000, isobutylene-isoprene copolymer (butyl elastomer), styrene-butadiene, copolymers having styrene-butadiene ratios of about 1:3 to about 3:, polyvinyl acetate having GPC weight average molecular weight of about 2,000 to about 90,000, polyisoprene, polyethylene, vinyl acetate-vinyl laurate copolymer having vinyl laurate content of about 5% to about 50% by weight of the copolymer, and combinations thereof.

In an embodiment, ranges for polyisobutylene are 50,000 to 80,000 G PC weight average molecular weight and for styrene-butadiene are 1:1 to 1:3 bound styrene-butadiene, for polyvinyl acetate are 10,000 to 65,000 GPC weight average molecular weight with the higher molecular weight polyvinyl acetates typically used in bubble gum base, and for vinyl acetate-vinyl laurate, vinyl laurate content of 10-45%.

Natural elastomers may include natural rubber such as smoked or liquid latex and guayule as well as natural gurus such as jelutong, lechi caspi, perillo, sorva, massaranduba balata, massaranduba chocolate, nispero, rosindinha, chicle, gutta hang kang, and combinations thereof. In an embodiment, the synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters such as glycerol esters or partially hydrogenated rosin, glycerol esters of polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing. The preferred elastomer plasticizers will also vary depending on the specific application, and on the type of elastomer that is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof. Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water-soluble bulk portion and one or more flavoring agents. The water-soluble portion can include bulk sweeteners and or other bulking and sweetening agents, including high-intensity sweeteners; flavoring agents, softeners, emulsifiers, colors, acidulants, fillers, antioxidants, and other components that provide desired attributes.

Softeners are added to the chewing gum in order to optimize the chewability and mouth feel of the gum. The softeners, which are also known as plasticizers and plasticizing agents, generally constitute between approximately 0.5% to about 15% by weight of the chewing gum. The softeners may include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk and sweetening agents typically constitute about 5% to about 95% by weight of the chewing gum, more typically, about 20% to about 80% by weight, and more commonly, about 30% to about 60% by weight of the gum. Sugar sweeteners generally include saccharide-containing components commonly known in the chewing gum art, including but not limited to, sucrose, dextrose, maltose, dextrin, dried invert sugar, fructose, levulose, galactose, corn syrup solids, and the like, alone or in combination. Sugarless sweeteners include, but are not limited to, sugar alcohols such as sorbitol, mannitol, xylitol, hydrogenated starch hydrolysates, maltitol, and the like, alone or in combination.

High-intensity sweeteners can also be used, alone or in combination, with the above bulk sweeteners, as well as in the long-duration flavor material. In an embodiment, sweeteners include, but are not limited to, sucralose, aspartame, N-substituted APM derivatives such as neotame, salts of acesulfame, alitame, saccharin and its salts, cyclamic acid and its salts, glycyrrhizinate, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Examples of low caloric bulking agents include: polydextrose; Raftilose; Raftilin; fructooligosaccharides (NutraFlora); palatinose oligosaccharide; guar gum hydrolysate (Sun Fiber); or indigestible dextrin (Fibersol). However, other low calorie bulking agents can be used.

In addition to the long-duration flavor material discussed above, a variety of additional flavoring agents can also be used, if desired. Of course some of the spray dried flavor not encapsulated with a vinyl polymer may be included with the long-duration flavor material. The flavor can be used in amounts of about 0.1% to about 15% of the gum, and preferably, about 0.2% to about 5% by weight. The amount of flavor in the long-duration flavor material may comprise about 0.1% to about 10% of the chewing gum composition. The additional flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

In general, chewing gum is manufactured by sequentially adding the various chewing gum ingredients to a commercially available mixer known in the art. After the ingredients have been thoroughly mixed, the gum mass is discharged from the mixer and shaped into the desired form such as rolling sheets and cutting into sticks, extruding into chunks or casting into pellets, which are then coated or panned.

Generally, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent. Further parts of the bulking agent are added to the mixer. Flavoring agents, such as the long-duration flavor material, are typically added with the final portion of the bulking agent. Other optional ingredients are added to the batch in a typical fashion, well known to those of ordinary skill in the art.

The entire mixing procedure typically takes from five to fifteen minutes, but longer mixing times may sometimes be required. Those skilled in the art will recognize that many variations of the above-described procedure may be followed.

### EXAMPLES—FLAVOR RETENTION

The first step in the invention was to make an encapsulated flavor that prevented volatilization of the flavor and retained the flavor over time. One of the most common fruit esters is ethyl butyrate (pineapple flavor). This material is used in a variety of fruit flavor blends for chewing gum. Because it is very volatile, it will dissipate from the chewing gum formula, which will modify the overall fruit flavor of the final product. By spray drying the ethyl butyrate, the flavor will be retained in the chewing gum matrix for a longer period of time. However, the spray drying encapsulant is very important since the flavor must be held in the encapsulating matrix as long as possible. Many standard encapsulants are not sufficiently effective to retain volatile flavors such as ethyl butyrate. As a result, tests were done to determine the extent of loss of ethyl butyrate in various encapsulants. A chewing gum composition was prepared according to the following formula.

| | % |
|---|---|
| Sugar | 58.23 |
| Gum Base | 19.30 |
| 45.5 Be Corn Syrup | 13.91 |
| Dextrose Monohydrate | 7.28 |
| Glycerin | 1.15 |
| Lecithin | 0.13 |
| Total | 100.0 |

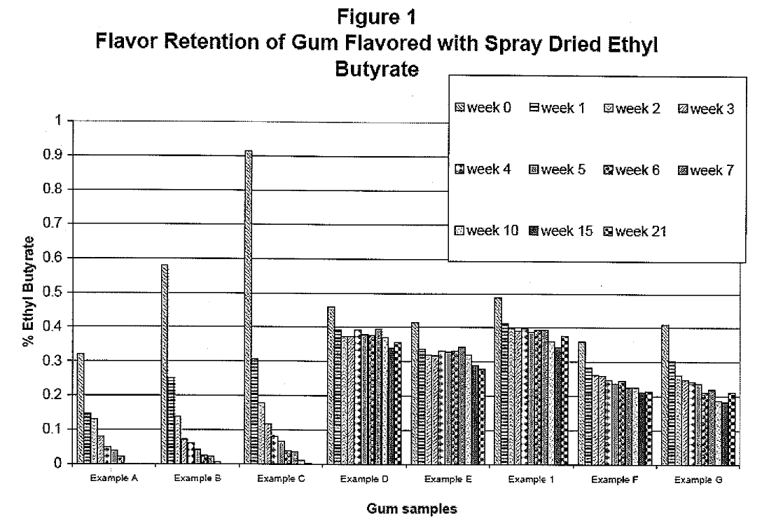

The encapsulated ethyl butyrate materials were added to the chewing gum and stored unwrapped at room temperature for up to 20 weeks. At different weekly intervals, samples were taken and analyzed for ethyl butyrate. The level of retained ethyl butyrate was recorded in Table 1 below, and the results graphed in FIG. 1.

Comparative Examples A, B, and C—To the above gum formula was added 0.5%, 1.0%, and 2.0% liquid ethyl butyrate, reducing the sugar level by an equal amount to make Examples A, B, and C, respectively.

Comparative Example D—To the above gum formula was added 5.9% of a spray dried ethyl butyrate made with 77% acacia gum and 4% fish gelatin, giving a spray dried material with an active ethyl butyrate of 8.57% and a level of 0.5% in the gum.

Comparative Example E—To the above gum formula was added 10.0% of a spray dried ethyl butyrate made with 38% acacia gum, 38% maltodextrin with a DE of 1, and 4% fish gelatin, giving a spray dried material with an active ethyl butyrate of 5% and an active level of 0.5% in the gum.

Comparative Example F—To the above gum formula was added 8.9% of a spray dried ethyl butyrate made with 79% acacia gum and 1% fish gelatin, giving a spray dried material with an active ethyl butyrate of 5.66% and an active level of 0.5% in the gum.

Comparative Example G—To the above gum formula was added 4.05% of a spray dried ethyl butyrate made with 60% corn syrup solids with a DE of 44, and 20% fish gelatin, giving a spray dried material with an active ethyl butyrate of 12.27% and an active level of 0.5% in the gum.

Inventive Matrix Example 1—To the above gum formula was added 5.55% of a spray dried ethyl butyrate made with 38% acacia gum, 38% corn syrup solids with a DE of 44, and 4% fish gelatin, giving a spray dried material with an active ethyl butyrate of 11.03% and an active level of 0.5% in the gum.

The amount of ethyl butyrate in each of the gum samples was analyzed at intervals from zero to 21 weeks. The percentage of ethyl butyrate in the gum is presented in Table 1 below.

TABLE 1

| | Comp. | Comp. | Comp. | Comp. | Comp. | Matrix | Comp. | Comp. |
|---|---|---|---|---|---|---|---|---|
| | Example A | Example B | Example C | Example D | Example E | Example 1 | Example F | Example G |
| Week 0 | 0.32 | 0.580 | 0.914 | 0.461 | 0.415 | 0.487 | 0.359 | 0.410 |
| Week 1 | 0.148 | 0.250 | 0.308 | 0.393 | 0.337 | 0.414 | 0.285 | 0.304 |
| Week 2 | 0.130 | 0.140 | 0.179 | 0.374 | 0.321 | 0.398 | 0.261 | 0.262 |
| Week 3 | 0.82 | 0.074 | 0.116 | 0.373 | 0.318 | 0.390 | 0.258 | 0.248 |
| Week 4 | 0.05 | 0.061 | 0.082 | 0.392 | 0.331 | 0.399 | 0.240 | 0.244 |
| Week 5 | 0.038 | 0.041 | 0.066 | 0.378 | 0.330 | 0.387 | 0.238 | 0.237 |
| Week 6 | 0.024 | 0.026 | 0.039 | 0.378 | 0.331 | 0.394 | 0.245 | 0.212 |
| Week 7 | | 0.023 | 0.035 | 0.396 | 0.342 | 0.394 | 0.226 | 0.220 |
| Week 10 | | 0.006 | 0.011 | 0.370 | 0.321 | 0.359 | 0.225 | 0.188 |
| Week 15 | | 0.001 | 0.003 | 0.341 | 0.289 | 0.343 | 0.211 | 0.186 |
| Week 21 | | | 0.001 | 0.357 | 0.28 | 0.377 | 0.215 | 0.212 |

As can be seen from the data in Table 1 and in FIG. 1, about 40% of liquid ethyl butyrate in Comparative Examples A, B and C was lost during processing, and over the next 10 weeks almost all of the remainder of the flavor was lost. Also depicted graphically in FIG. 1, there is a slight loss of ethyl butyrate over 21 weeks for example D and considerable loss of ethyl butyrate from examples E, F, and G, but less of a loss of flavor ester in the Inventive Matrix Example 1.

In another set of examples, a mixed fruit flavor blend was made with two volatile flavor esters, ethyl butyrate and isoamyl acetate. These were blended with orange oil and lemon oil in the following proportions:

| | % |
|---|---|
| ethyl butyrate | 50 |
| isoamyl acetate | 25 |
| orange oil | 15 |
| lemon oil | 10 |
| | 100 |

This flavor was spray dried with three different encapsulating compositions. One was with 100% acacia gum (Comparative Examples J and K), the second with a 50:50 blend of acacia gum and 44 DE corn syrup solids (Comparative Examples L and M), and the third with an embodiment of the inventive composition of 1:1:0.1125 of acacia gum:44 DE corn syrup solids:fish gelatin (Inventive Matrix Examples 2 and 3). The encapsulating compositions were dissolved in water at 44.4% solids, and then the mixed fruit flavor was dispersed in the water at a 10% level, giving a mixture of 50% water, 40% encapsulants, and 10% flavor.

Each of the three compositions were spray dried at two different inlet temperatures (190° C. or 200° C.) to determine which temperature would give increased loading of the flavor into the encapsulant. Based on the results, more loading could be achieved with an inlet temperature of 190° C. Each of the six examples was used to make chewing gum in the formula shown above.

Comparative Example H—To the above gum formula was added 0.81% mixed fruit flavor with a corresponding decrease in the amount of sugar.

Comparative Example J—To the above gum formula was added 4.8% of the spray dried flavor made with 100% acacia gum at 190° C., giving a spray dried material with an active fruit flavor level of 16.95% and an active level of 0.81% in the gum.

Comparative Example K—To the above gum formula was added 7.2% of the spray dried flavor made with 100% acacia gum at 200° C., giving a spray dried material with an active fruit flavor level of 11.3% and an active level of 0.81% in the gum.

Comparative Example L—To the above gum formula was added 6.8% of the spray dried flavor made with 50% acacia gum and 50% 44 DE corn syrup solids at 190° C., giving a spray dried material with an active fruit flavor level of 11.95% and an active level of 0.81% in the gum.

Comparative Example M—To the above gum formula was added 6.2% of the spray dried flavor made with 50% acacia gum and 50% 44 DE corn syrup solids at 200° C., giving a spray dried material with an active fruit flavor level of 13.11% and an active level of 0.81% in the gum.

Inventive Matrix Example 2—To the above gum formula was added 4.9% of the spray dried flavor made with 38% acacia gum, 38% 44 DE corn syrup solids, and 4% fish gelatin at 190° C., giving a spray dried material with an active fruit flavor level of 16.52% and an active level of 0.81% in the gum.

Inventive Matrix Example 3—To the above gum formula was added 5.1% of the spray dried flavor made with 38% acacia gum, 38% 44 DE corn syrup solids, and 4% fish gelatin at 200° C., giving a spray dried material with an active fruit flavor level of 15.82% and an active level of 0.81% to in the gum.

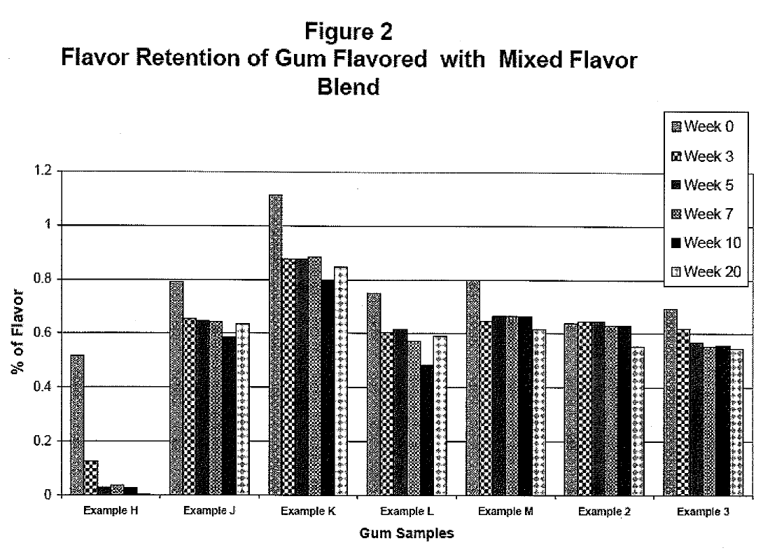

Stability test results of the spray dried materials in gum are shown in Table 2, and depicted in FIG. 2. The percentage amount of fruit flavor in the gum at various time intervals is recorded below.

TABLE 2

| | Comparative | Comparative | Comparative | Comparative | Comparative | Matrix | Matrix |
|---|---|---|---|---|---|---|---|
| | Example H | Example J | Example K | Example L | Example M | Example 2 | Example 3 |
| Week 0 | 0.515 | 0.790 | 1.113¹ | 0.751 | 0.800 | 0.640 | 0.694 |
| Week 3 | 0.125 | 0.654 | 0.878 | 0.603 | 0.648 | 0.648 | 0.619 |
| Week 5 | 0.030 | 0.645 | 0.878 | 0.617 | 0.666 | 0.645 | 0.569 |
| Week 7 | 0.035 | 0.643 | 0.885 | 0.572 | 0.664 | 0.630 | 0.552 |
| Week 10 | 0.024 | 0.586 | 0.793 | 0.482 | 0.663 | 0.632 | 0.556 |
| Weak 20 | 0.004 | 0.636 | 0.348 | 0.591 | 0.618 | 0.554 | 0.547 |

¹The Week 0 amount of 1.113% flavor is higher than the amount of flavor that was supposedly added to the gum. While this result could be simply an error due to random analytical error, it is more likely that either more than 7.2% of the weight of the gum of the spray dried flavor was added (formulation error),or that the spray dried flavor actually contained more than 11.3% active flavor (analytical error). In either event, it is still clear from the data, and especially FIG. 2, that what flavor there was in Comparative Example K at Week 0 was seriously lost by the time the Week 20 measurement was made.

The difference in inlet temperature of 190° C. vs. 200° C. showed that acacia gum gave higher loading levels at 190° C. but slightly less shelf life. The mixture of acacia gum arid corn syrup solids gave the same loading levels, but better shelf life at 200° C. The inventive composition gave both higher loading and improved shelf life, but better shelf life was obtained for the Inventive Matrix Example 2 spray dried at 190° C.

Other experiments have demonstrated that the spray dried matrix of some embodiments of the invention give better stability results compared to other conventional encapsulation processes, and give stability results as good as more complicated and expensive encapsulation processes.

### Flavor Duration

The next step in the invention is to make a form of the encapsulated flavor that will have a long flavor duration in chewing gum. When spray-dried fruit flavor was used to flavor a laboratory scale gum formulation, sensory panelists detected a “citrus” or “orangey” flavor that they considered an off flavor. To reduce this off flavor, the levels of ethyl butyrate and isoamyl acetate were increased in the fruit flavor formula. When the level of these two flavors was increased, the percentage of the other flavors decreased. This modified flavor was then encapsulated by a spray drying process using the ingredients listed in Table 3 to form Inventive Matrix 4.

TABLE 3
Inventive Matrix 4

| | |
|---|---|
| Acacia Senegal (Valspray A from Valmar) | 266.0 grams |
| Corn Syrup Solids DE 42 | 266.0 grams |
| Fish Gelatin | 26.6 grams |
| Fruit flavor | 141.4 grams |

Gum arabic from Acacia Senegal was hydrated overnight to make a 40% solution. Fish gelatin was diluted in water at room temperature. The fish gelatin solution and the corn syrup solids were poured into the gum arabic solution and mixed for 5 minutes. The flavor was added at the end and mixed to form a milky solution. All the ingredients were blended for 10-15 seconds to get a good mix with a solids content of 46.85%. The mixture was homogenized under 3000 psi to obtain an emulsion with internal phase droplet size of around 5-10μ. Immediately, this homogenized mix was spray-dried using a Spray Tech spray dryer under the following conditions: inlet temperature 200° C., outlet temperature 100° C., and air pressure of 7500 psi. The dried flavor had a theoretical flavor level of 20.14%.

The Inventive Matrix 4 powder was dry blended with polyvinyl acetate to form a mixture prior to extrusion. (Of course the inventive matrix of Examples 1, 2 and 3 above may also be combined with a vinyl polymer to make a long duration flavor material.) The mixture that was extruded consisted of: 47.5% of the spray-dried flavor, 50% polyvinyl acetate (VINNAPAS® B 30 SP), 1% acesulfame-K and 1.5% aspartame. All the ingredients were mixed to obtain a homogeneous mixture with a ratio of 47.5/50/1/1.5 flavors, polyvinyl acetate, acesulfame-K and aspartame. The temperature settings on the extruder were as follows:

| | Zone | | | | | | |
|---|---|---|---|---|---|---|---|
| | 7 | 6 | 5 | 4 | 3 | 2 | 1 |
| Temperature (° C.) | 85 | 85 | 85 | 85 | 85 | 70 | 50 |

The screw speed was held constant at 200 rpm. The extruded ribbon was allowed to cool down, stored at 40° F. and later poured into a blender to reduce the particles size. The reduced size particles were screened to obtain desired cuts of particle sizes. Two sizes of particles were collected. One cut had a size that would pass through a USA standard testing sieve #18 and stay in a sieve #20. This product had an average particle size of about 1000μ. A second cut was taken between sieve #100 and #140 to obtain a particle size of about 100μ. These particles were used to flavor a chewing gum composition as listed in Table 4 to form Examples 5 and 6. The flavor loading of the extruded long-duration flavor material was 8.96%. In addition, three other test samples were made, each using a spray drying matrix different than that of the present invention. These products were mixed with polyvinyl acetate, acesulfame-K and aspartame and extruded at the same ratios and under the same conditions and as Inventive Matrix 4. The resulting extrudate was also cooled a ground, and a 1000μ average particle size cut collected. These were also mixed into the gum composition of Table 4 to form comparative examples N, P and Q.

TABLE 4

| | | Examples 5, 6, |
|---|---|---|
| | Control | N, P and Q |
| Ingredient | (%) | (%) |
| Sugar | 57.42 | 48.23 |
| Gum Base | 19.30 | 19.30 |
| Corn Syrup (39 DE, 45.5 Be) | 13.91 | 13.91 |
| Dextrose | 7.28 | 7.28 |
| Glycerin | 1.15 | 1.15 |
| Liquid flavor | 0.81 | — |
| Encapsulated favor | — | 10.00 |
| Lecithin | 0.13 | 0.13 |

### Sensory Evaluation

Flavor loading was determined by gas chromatography. The Control sample flavored with liquid fruit flavor had a load of about 0.63% flavor by weight of the gum. Flavor loading for gum using the long-duration flavor material of the present invention described above was about 0.69%.

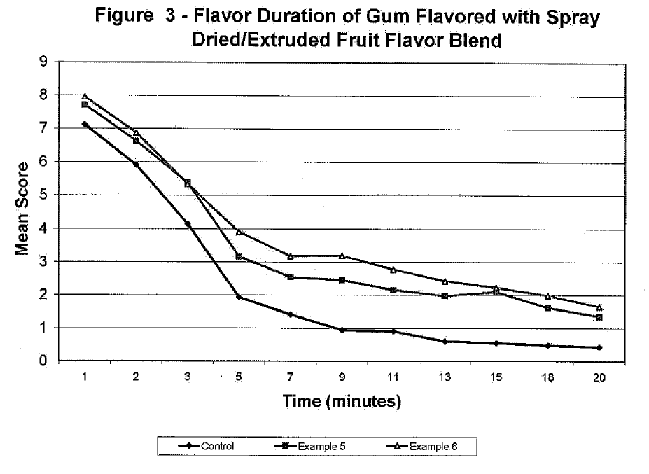

The Control, Example 5 (100μ average particle size), Example 6 (1000μ average particle size) and two of the other test samples (comparative examples N and P) were evaluated using a 20-minute time-intensity method. Sensory screening of comparative example Q indicated only a slight flavor extension, and so comparative example Q was not evaluated in the 20-minute time-intensity evaluation. The other samples were evaluated by 10 trained panelists, at regular time intervals during the course of 20 minutes. Results were given in a 10-point scale. Of the four samples, Example 6 had longer flavor and sweetness duration than the other samples. Example 6 was significantly higher than the Control for sweetness at 3 minutes through 20 minutes. Example 6 was also significantly higher than the Control for flavor from 5 minutes to 18 minutes during the evaluation. The results are given in Tables 5 and 6 below, and in FIGS. 3-6.

TABLE 5
Flavor Duration

| | | Example 5 | Example 6 | Comp. Ex. N | Comp. Ex. P |
|---|---|---|---|---|---|
| | Control | 100μ | 1000μ | 1000μ | 1000μ |
| 1 minute | 7.12 | 7.72 | 7.96 | 7.35 | 7.61 |
| 2 minute | 5.91 | 6.63 | 6.88 | 6.33 | 6.20 |
| 3 minute | 4.14 | 5.38 | 5.34 | 4.97 | 4.33 |
| 5 minute | 1.93 | 3.16 | 3.90 | 3.21 | 2.46 |
| 7 minute | 1.41 | 2.54 | 3.18 | 2.59 | 1.74 |
| 9 minute | 0.94 | 2.45 | 3.19 | 2.04 | 1.54 |
| 11 minute | 0.90 | 2.15 | 2.77 | 1.92 | 1.41 |
| 13 minute | 0.60 | 1.97 | 2.42 | 1.65 | 1.19 |
| 15 minute | 0.55 | 2.09 | 2.22 | 1.70 | 1.18 |
| 18 minute | 0.48 | 1.62 | 1.98 | 1.45 | 0.99 |
| 20 minute | 0.43 | 1.35 | 1.65 | 1.11 | 0.84 |

TABLE 6
Sweetness Duration

| | | Example 5 | Example 6 | Comp. Ex. N | Comp. Ex. P |
|---|---|---|---|---|---|
| | Control | 100μ | 1000μ | 1000μ | 1000μ |
| 1 minute | 8.32 | 8.79 | 9.53 | 8.55 | 8.75 |
| 2 minute | 6.54 | 7.84 | 8.38 | 7.33 | 7.26 |
| 3 minute | 4.71 | 6.25 | 6.67 | 5.77 | 5.01 |
| 4 minute | 3.22 | 4.83 | 5.60 | 5.11 | 3.99 |
| 5 minute | 2.20 | 4.15 | 4.95 | 4.07 | 3.00 |
| 7 minute | 1.62 | 3.16 | 4.14 | 3.82 | 2.51 |
| 9 minute | 1.14 | 3.10 | 4.10 | 3.72 | 2.25 |
| 11 minute | 0.99 | 2.78 | 3.67 | 3.22 | 1.92 |
| 13 minute | 0.70 | 2.48 | 3.3 | 3.22 | 1.82 |
| 15 minute | 0.62 | 2.63 | 2.94 | 2.77 | 1.67 |
| 18 minute | 0.46 | 1.96 | 2.56 | 2.47 | 1.30 |
| 20 minute | 0.40 | 1.71 | 2.24 | 2.06 | 1.36 |

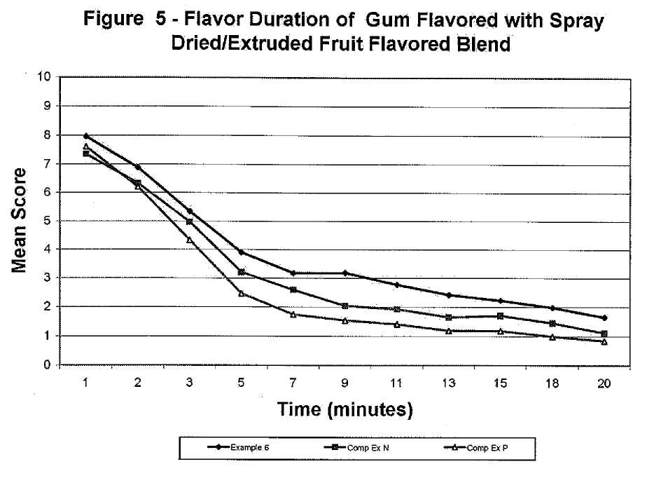

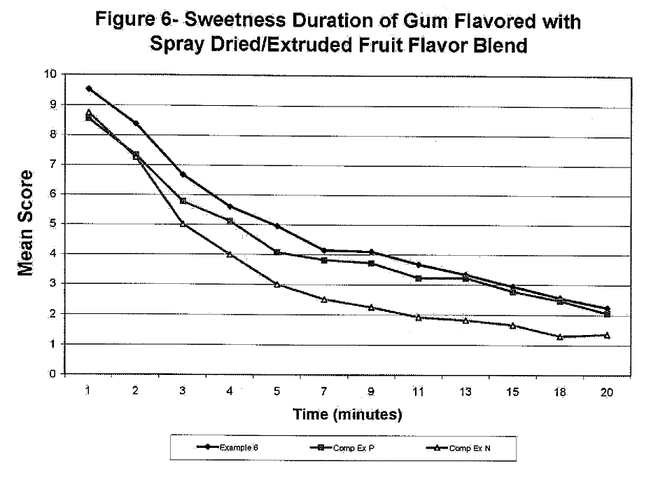

From this data it can be seen that the flavor level at 18 minutes for Example 6 was about the same of the flavor level of the control at about five minutes. This is a very significant increase in the flavor duration. It is typical that spray-dried flavors are water-soluble and have low flavor duration, even lower than the same amount of flavor added as a liquid. These results show that when the spray-dried flavors are encapsulated in polyvinyl acetate, a hydrophobic barrier is formed and the water solubility of the particle is reduced, producing longer flavor duration. What is even more surprising is that the flavor duration of the present invention was extended compared to other spray dried flavors encapsulated with polyvinyl acetate. FIGS. 5 and 6 show how the Example 6 material provided a longer duration than either of the comparative Examples N and P, which were of a similar particle size and polyvinyl acetate encapsulation.

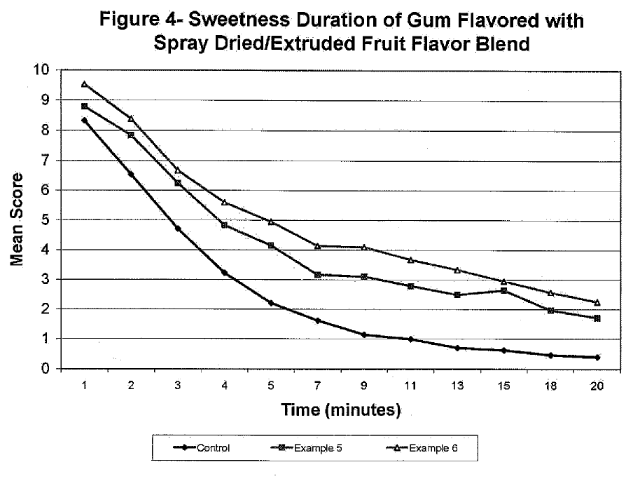

FIGS. 3 and 4 also show that particle size plays an important role in flavor duration. While Example 5 and Example 6 both had longer flavor and sweetness than the Control, Example 5, flavored with extruded particles sized under 100μ, had a shorter duration than Example 6, flavored with particles of 1000μ. This is believed to be because particles with a size of 100μ have a higher dissolution rate than particle with a size of 1000μ. So while spray-dried particles encapsulated in the vinyl polymer matrix take more time to be dissolved than just spray-dried particles, large particles have a reduced ratio of surface area to volume, which result in even slower dissolution, resulting in longer flavor duration.

It should be appreciated that the compositions and methods of the present invention are capable of being incorporated in the form of a variety of embodiments, only a few of which have been illustrated and described above. The invention may be embodied in other forms without departing from its spirit or essential characteristics. The described embodiments are to be considered in all respects only as illustrative and not restrictive, and the scope of the invention, therefore, is indicated by the appended claims rather than by the foregoing description. All changes that come within the meaning and range of equivalency of the claims are to be embraced within their scope.

1. A method of encapsulating flavor to provide a long-duration flavor material comprising:
a) providing a flavor;
b) providing encapsulating ingredients comprising
i) acacia gum,
ii) corn syrup solids having a DE of between about 24 and about 44 or equivalent hydrogenated starch hydrolysates, and
iii) hydrocolloid material;
c) encapsulating the flavor with a matrix comprising about 30% to about 60% acacia gum, about 30% to about 60% of said corn syrup solids or hydrogenated starch hydrolysates, and about 2% to about 20% hydrocolloid material to form an encapsulated flavor material; and
d) further combining the encapsulated flavor material with a vinyl polymer to incorporate the encapsulated flavor into a long-duration flavor material comprising said vinyl polymer.

2. The method of claim 1 wherein the long-duration flavor material is ground to a reduced particle size and separated for use, and the particles collected for use have a weight average size of between about 100 microns and about 1000 microns.

3. The method of claim 1 wherein the long-duration flavor material further comprises a high-intensity sweetener.

4. The method of claim 1 wherein the long-duration flavor material comprises about 30% to about 80% vinyl polymer.

5. The method of claim 1 wherein the long-duration flavor material comprises about 4% to about 15% flavor, about 10% to about 30% gum arabic, about 10% to about 30% of said corn syrup solids or hydrogenated starch hydrolysates, about 1% to about 10% hydrocolloid material and about 20% to about 75% vinyl polymer.

6. The method of claim 1 wherein the matrix is formed by a spray drying process.

7. The method of claim 1 wherein the encapsulated flavor and vinyl polymer are mixed together and heated to a temperature of between about 75° C. and about 110° C.

8. The method of claim 1 wherein the vinyl polymer comprises polyvinyl acetate having a weight average molecular weight of between about 25,000 and about 100,000.

9. The method of claim 1 wherein the vinyl polymer comprises polyvinyl acetate having a weight average molecular weight of between about 50,000 and about 80,000.

10. The method of claim 1 wherein the vinyl polymer is selected from the group consisting of polyvinyl acetate; polyvinyl stearate; polyvinyl butyrate; polyvinyl propionate; polyvinyl alkanoates; copolymers of vinylacetate, vinyllaurate, vinylacetate and vinylalkanoates; and polymers of alkenyl-vinylacetates, and mixtures thereof.

11. The method of claim 1 wherein the hydrocolloid material is selected from the group consisting of carrageenan, agar-agar, alginates, tamarind, pectin, pullulan, guar gum and guar gum hydrolysates, karaya gum, pectin, gellan gum, curdlan, arabinogalactan, gelatin and mixtures thereof

12. The method of claim 1 wherein the hydrocolloid material is selected from the group consisting of carrageenan and gelatin.

13. The method of claim 1 wherein the encapsulating matrix comprises acacia gum, corn syrup solids and gelatin.

14. The method of claim 1 wherein the encapsulating matrix comprises acacia gum, corn syrup solids and a hydrocolloid selected from the group consisting of carrageenan, pectin, agar-agar and combinations thereof.

15. A long-duration flavor material comprising:
a) about 30% to about 80% vinyl polymer; and
b) about 20% and about 70% encapsulated flavor; wherein the encapsulated flavor comprises about 5% to about 25% flavor and a matrix encapsulating the flavor, the matrix comprising:
i) about 30% to about 60% acacia gum,
ii) about 30% to about 60% corn syrup solids having a DE of between about 24 and about 44 or equivalent hydrogenated starch hydrolysates, and
iii) about 2% to about 20% hydrocolloid material;
wherein the matrix comprises at least 80% acacia gum and corn syrup solids or hydrogenated starch hydrolysates on a combined basis.

16. The long-duration flavor material of claim 15 having a weight average particle size of between about 100 microns and about 1000 microns.

17. The long-duration flavor material of claim 15 wherein the encapsulated flavor matrix comprises about 5% to about 25% flavor, about 24% to about 48% acacia gum, about 24% to about 48% of said corn syrup solids or hydrogenated starch hydrolysates and about 2% to about 10% hydrocolloid material.

18. The long-duration flavor material of claim 15 further comprising a high-intensity sweetener.

19. The long-duration flavor material of claim 15 wherein the encapsulating matrix comprises acacia gum, corn syrup solids and gelatin.

20. A method of making a chewing gum product comprising the steps of:
a) encapsulating a flavor in a matrix comprising
i) about 30% to about 60% acacia gum,
ii) about 30% to about 60% corn syrup solids having a DE of between about 24, and about 44 or equivalent hydrogenated starch hydrolysates, and
iii) about 2% to about 20% hydrocolloid material, the matrix comprising at least 80% acacia gum and corn syrup solids or hydrogenated starch hydrolysates on a combined basis;
b) further combining the encapsulated flavor material with a vinyl polymer to incorporate the encapsulated flavor into a long-duration flavor material comprising said vinyl polymer;
c) mixing the long-duration flavor material with gum base and one or more bulking and sweetening agents to form a chewing gum composition; and
d) forming the chewing gum composition into a chewing gum product.

21. The method of claim 20 wherein the long-duration flavor material has a weight average particle size of between about 100 microns and about 1000 microns when it is mixed with the gum base.

22. The method of claim 20 wherein the encapsulating matrix comprises acacia gum, corn syrup solids and gelatin.

23. A chewing gum composition comprising:
a) about 5% to about 95% gum base;
b) about 5% to about 95% bulking and sweetening agents; and
c) about 0.1% to about 15% flavor, wherein at least part of the flavor comprises a long-duration flavor material comprising a vinyl polymer encapsulated matrix, wherein the matrix comprises
i) about 30% to about 60% acacia gum,
ii) about 30% to about 60% corn syrup solids having a DE of between about 24 and about 44 or equivalent hydrogenated starch hydrolysates, and
iii) about 2% to about 20% hydrocolloid material, the matrix comprising at least 80% acacia gum and corn syrup solids or hydrogenated starch hydrolysates on a combined basis.

24. The chewing gum composition of claim 23 wherein the long-duration flavor material has a flavor loading of between about 5% and about 20%.

25. The chewing gum composition of claim 23 wherein the long-duration flavor material comprises about 1% to about 20% of the chewing gum composition.

26. The chewing gum composition of claim 23 wherein the long-duration flavor material has a ratio of vinyl polymer:encapsulated flavor matrix of between about 3:1 and about 1:3.
